(19) United States
(12) Patent Application Publication
(10) Pub. No.: US 2014/0343981 A1
(43) Pub. Date: Nov. 20, 2014

(54) REAL TIME VEHICLE DATA MANAGEMENT AND ANALYTICS

(71) Applicant: SAP AG, Walldorf (DE)

(72) Inventors: Guy Blank, Tel Aviv (IL); Maxim Drabkin, Haifa (IL)

(73) Assignee: SAP AG, Walldorf (DE)

(21) Appl. No.: 13/897,596

(22) Filed: May 20, 2013

(51) Int. Cl. G06Q 10/06; G07C 5/00

(52) U.S. Cl. CPC G06Q 10/0631; G07C 5/008
USPC 705/7.12

(57) ABSTRACT

Disclosed is a platform for real time management of vehicle data in an enterprise. The vehicle data may be evaluated by one or more rules. Based on outcomes of the evaluation of the rules, alerts may be provided to a user of the platform and/or to drivers (operators) of the vehicles. Further, the enterprise's backend systems may be invoked to initiate activity in the backend system depending on outcomes of evaluating the rules using the vehicle data. Backend activity may include initiating purchase orders, updating backend system databases, initiating workflows in the enterprise, and other business processes.

### BACKGROUND

Unless otherwise indicated herein, the approaches described in this section are not prior art to the claims in this application and are not admitted to be prior art by inclusion in this section.

Modern vehicles are equipped with the ability to collect various metrics (e.g., steering wheel angle, GPS position, vehicle speed, etc.), and can expose those metrics to external systems separate from the vehicle. In a business enterprise that owns and maintains a fleet of vehicles, the volume of data that can be collected from the vehicles during their operation can be enormous, especially considering that some of the data may be real time data that is constantly being collected.

### BRIEF DESCRIPTION OF THE DRAWINGS

FIG. 1 shows a high level block diagram of a data collection platform in accordance with the present disclosure.

FIG. 2 illustrates an example of a hardware implementation of the platform of FIG. 1.

FIG. 3 is a high level process flow of processes in the platform in accordance with the present disclosure.

FIG. 3A shows an example of vehicle data that the platform may receive.

FIG. 4 illustrates an example of how rules may be processed in accordance with some embodiments of the present disclosure.

FIG. 5 shows a startup screen of a GUI in accordance with a particular embodiment of the present disclosure.

FIGS. 6, 7, 7A, and 7B illustrate examples of real time processing of vehicle data as it may appear in the GUI.

FIGS. 8 and 8A illustrate an example of processing an alert as it may appear in the GUI.

FIG. 9 illustrates how alerts may be collected and presented in a notification GUI.

FIGS. 9A and 9B illustrate how a user may initiate an action with the backend systems of the enterprise from the notification GUI.

FIGS. 10 and 10A represent an example of a GUI for generating a report.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

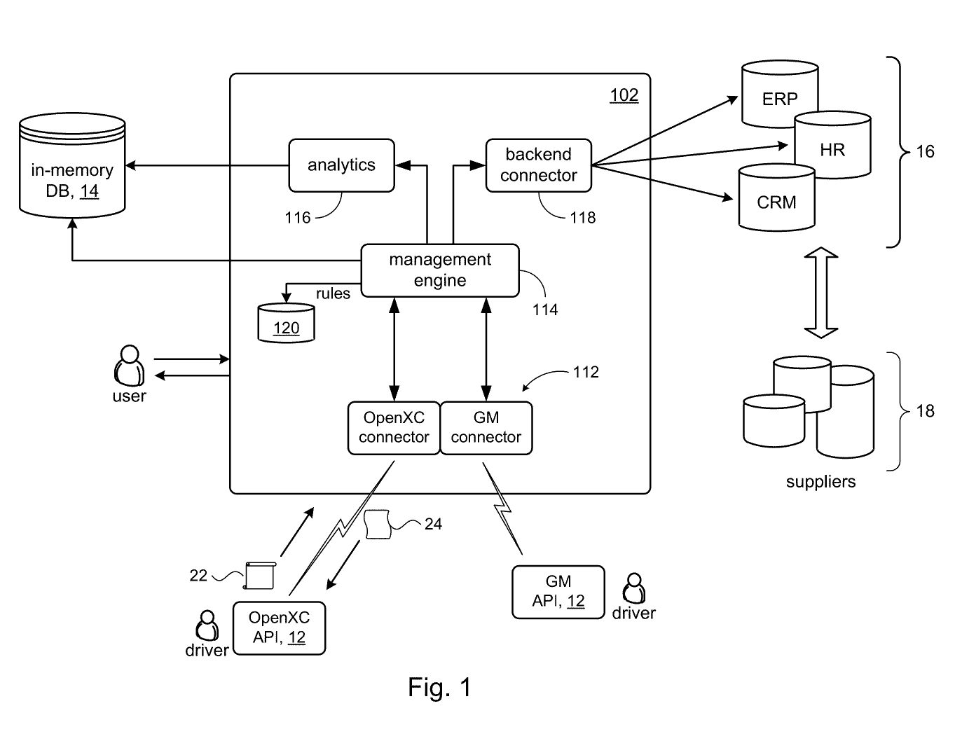

FIG. 1 shows a high level block diagram of a vehicle data management platform (platform) 102 in accordance with embodiments of the present disclosure. The platform 102 may be used to manage a fleet of vehicles 12 in an enterprise. The platform 102 may communicate with the vehicles 12 using any suitable communication application programming interfaces (APIs). For example, OpenXC is an example of a vehicle communication API by the Ford Motor Company; another vehicle communication API is the GM API from the General Motors Company.

The platform 102 may include a vehicle connector module 112 for each kind of communication API for communications with the vehicles 12 in the fleet. In some embodiments, the vehicle connector modules 112, each, may include any necessary radio communication hardware and/or communication software in order to communicate according to the specific communication API. In other embodiments, the vehicle connector modules 112 may use common communication hardware. Additional connector modules 112 may be added to the platform 102 to support new vehicle communication APIs.

Each vehicle 12 may include an on-board processor(s) to collect vehicle data 22 and to send a constant stream of vehicle data from the vehicle to the platform 102. The vehicle data 22 may include information about the current operating conditions of the vehicle; e.g., speedometer readout, odometer readout, fuel level, oil level, lamp status information (e.g., bulb burned out), seat belt usage information, and the like. Depending on the extent and sophistication of the on-board processor(s), the vehicle data 22 may include information such as the steering wheel angle, vehicle acceleration, braking actions, occurrences of wheel slippage, current drive gear, and so on. The vehicle data 22 may also include information about the driver/operator of the vehicle. For example, each driver may have to register or otherwise log in with the on-board computer before operating the vehicle. Such information may be included in the vehicle data 22.

In some embodiments, the vehicle data 22 may be streamed to the platform 102. For example, data samples of the vehicle's operations may be collected periodically (e.g., once a second, or when a state change has occurred like turning on the engine, opening a door, etc.) and sent to the platform 102. The vehicle's current location (e.g., obtained using a GPS device) may be included in the vehicle data 22. By streaming the vehicle data 22, the platform 102 can receive real time information about the enterprise's fleet of vehicles; e.g., who is driving what vehicle, where is the vehicle being driven, how fast, and so on. In various embodiments, the vehicle data 22 may be packaged in any suitable data format. For example, the vehicle data 22 may be formatted as a stream of XML data, JSON data, and so on. In some embodiments, each vehicle connector module 112 may translate the vehicle data 22 it receives into a common internal data format for processing by the other components of the platform 102.

The platform 102 may include a management engine 114. Tasks of the management engine 114 include receiving vehicle data 22 from the vehicle connector modules 112 and storing the data in a suitable data storage system 14. In some embodiments, for example, the data storage system 14 may be an in-memory database system such as the SAP® HANA® in-memory database platform. In other embodiments, other kinds of database systems may be used. The management engine 114 may receive and process rules, which may be stored in a rules data store 120, for triggering activity in the backend systems 16 of the enterprise, and issuing alerts (e.g., 24). The management engine 114 may also provide a user interface (UI) to a user (e.g., fleet manager) of the platform 102.

An analytics component 116 may perform various queries and analyses on the vehicle data 22 stored in the data storage system 14. The analytics component 116 may provide real time analytics on the vehicle data 22 as the data is received by the platform 102. The fleet manager may, for example, monitor the driving behavior of their drivers to assess risky or dangerous driving habits, assess driving patterns that may be fuel inefficient, and so on. The analytics component 116 may also perform retrospective analyses on the collected vehicle data 22. This allows the platform 102 to provide insight on long term patterns, such as identifying wear and tear on the vehicles (e.g., brakes, engine, etc.), identifying overall driver behavior, and so on.

A backend connector 118 may provide connectivity between the platform 102 and the enterprise's backend systems 16. Typical backend systems 16 include enterprise resource planning (ERP) systems, customer relations management (CRM) systems, human resources (HR) systems, and the like. Some of the backend systems 16 may communicate with suppliers 18 of parts for the fleet's vehicles, service providers (e.g., vehicle repair and maintenance), emergency road service, and so on.

In some embodiments, the components shown in FIG. 1 may be implemented in the “cloud” (e.g., software as a service, infrastructure as a service, and so on), in hardware on the premises of the enterprise, or as a combination of both. For example, in some embodiments, the data storage system 14 may be a storage service provided in the cloud, while the rest of the system is provided in hardware.

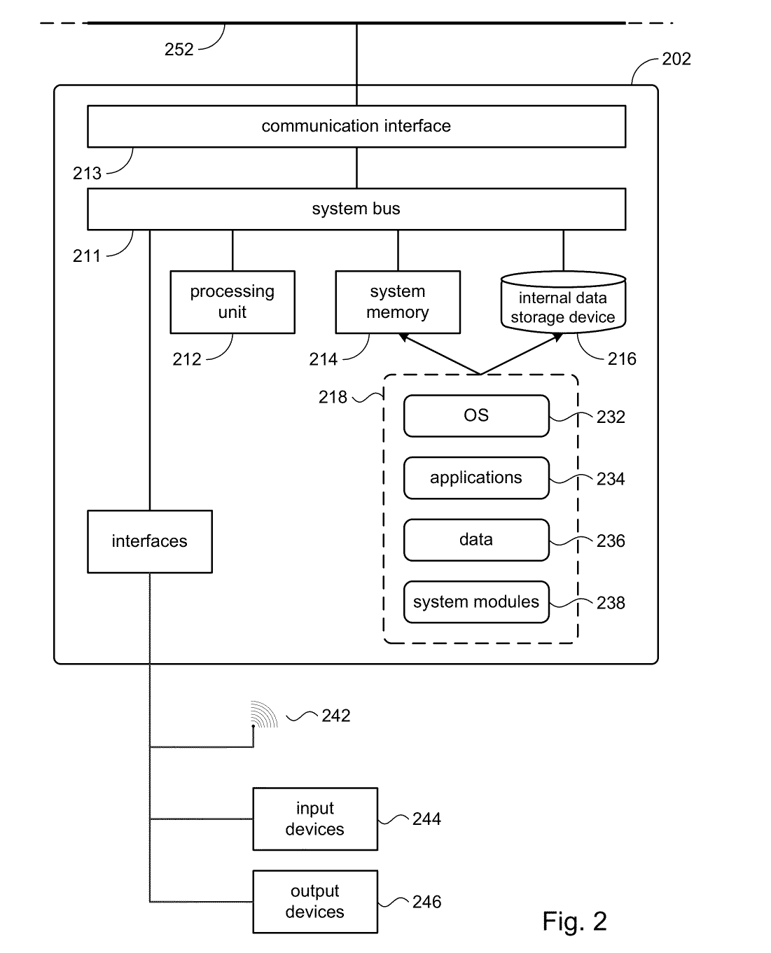

Referring to FIG. 2, an illustrative hardware implementation of the platform 102 may include a computer system 202 having a processing unit 212, a system memory 214, and a system bus 211. The system bus 211 may connect various system components including, but not limited to, the processing unit 212, the system memory 214, an internal data storage device 216, and a communication interface 213.

The processing unit 212 may comprise a single-processor configuration, or may be a multi-processor architecture. The system memory 214 may include read-only memory (ROM) and/or random access memory (RAM). The internal data storage device 216 may be an internal hard disk drive (HDD), a magnetic floppy disk drive (FDD, e.g., to read from or write to a removable diskette), an optical disk drive (e.g., for reading a CD-ROM disk, or to read from or write to other high capacity optical media such as the DVD), and so on. In a configuration where the computer system 202 is a mobile device, the internal data storage device 216 may be a flash drive.

The internal data storage device 216 and its associated non-transitory computer-readable storage media may provide nonvolatile storage of data, data structures, computer-executable instructions, and so forth. Although the description of computer-readable media above refers to an HDD, a removable magnetic diskette, and a removable optical media such as a CD or DVD, it is noted that other types of media which are readable by a computer, such as zip drives, magnetic cassettes, flash memory cards, cartridges, and the like, may also be used, and further, that any such media may contain computer-executable instructions for performing the methods disclosed herein.

The system memory 214 and/or the internal data storage device 216 may store a number of program modules, including an operating system 232, one or more application programs 234, program data 236, and other program/system modules 238. For example, the application programs 234, which when executed, may cause the computer system 202 to perform method steps disclosed herein. The application programs 234 may comprise the software for the various elements of the platform 102 including the vehicle connector modules 112, the management engine 114, the analytics component 116, and the backend connector 118. The internal data storage device 216 may serves as the rules data store 120 for storing rules.

The user (e.g., fleet manager) may access the computer system 202 using a suitable input device 244 (e.g., keyboard, mouse, touch pad, etc.) and a suitable output device 246, (e.g., display screen). In a configuration where the computer system 202 is a mobile device, input and output may be provided by a touch sensitive display. A suitable radio interface 242 may be provided for communications with the fleet vehicles 12.

The computer system 202 may operate in a networked environment using logical connections via wired and/or wireless communications to one or more remote computers (not shown) over a communication network 252. The communication network 252 may be a local area network (LAN) and/or larger network, such as a wide area network (WAN). In some embodiments, the communication network 252 may connect the platform 102 to the backend systems 16. The backend connector 118 may communicate with the backend systems 16 over the communication network 252 via the communication interface 213.

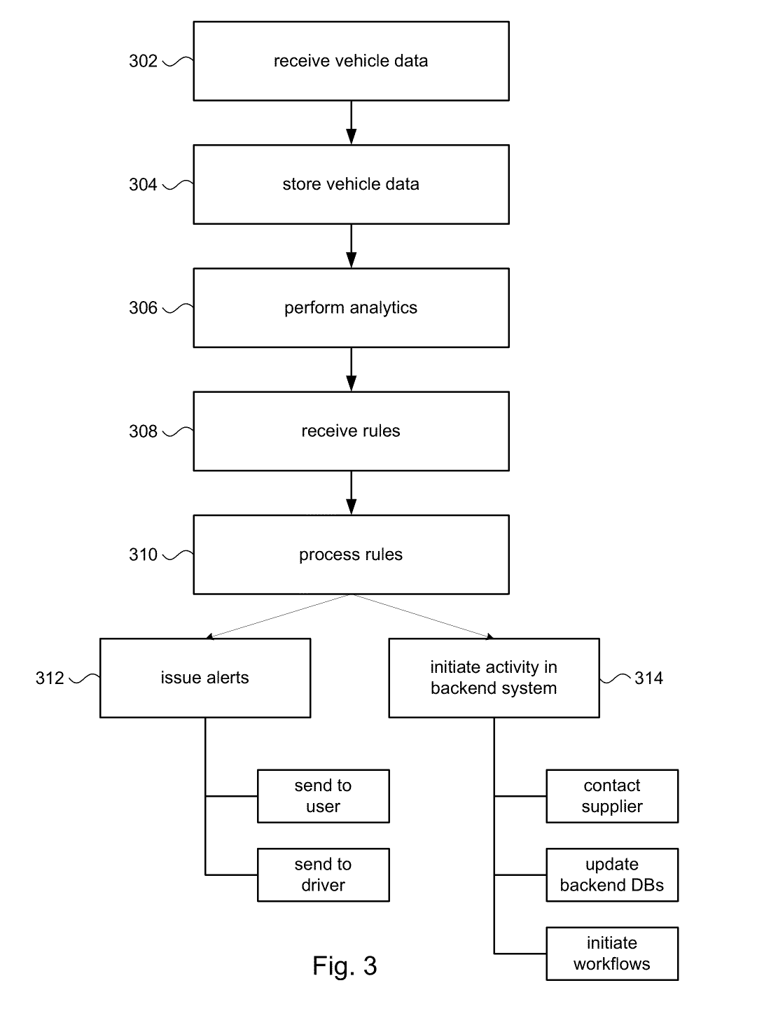

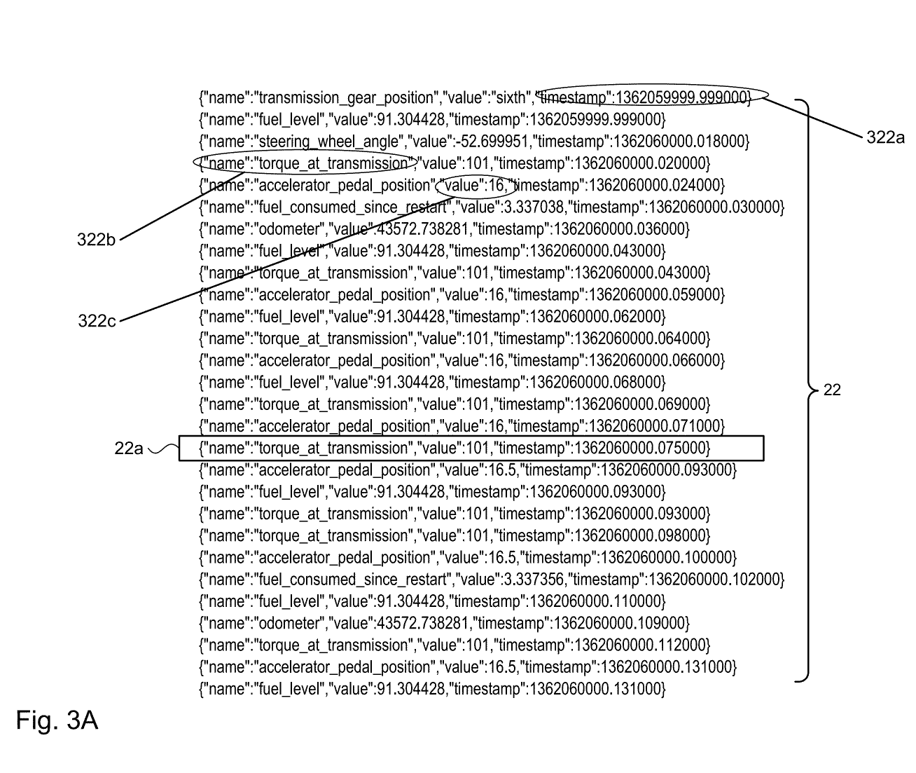

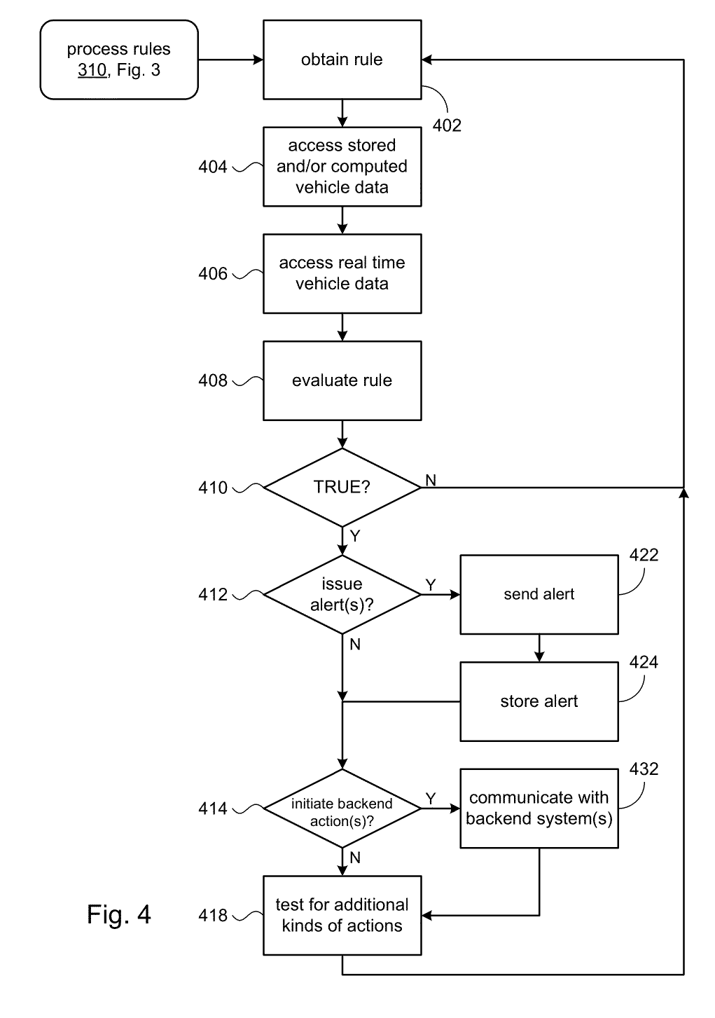

Referring to FIG. 3, processing of the platform 102 in accordance with the present disclosure will now be described in connection with the high level process flow shown in the figure. At block 302, the platform 102 receives vehicle data 22 from the fleet of vehicles 12 currently in operation. The vehicle data 22 is initially received from a vehicle 12 by a vehicle connector module 112 and then provided to the management engine 114. Since the format of the vehicle data 22 may vary from one API to another, in some embodiments, each vehicle connector module 112 converts the data into an internal common format so that the management engine 114 can receive and process data from all vehicles 12 without having to do the conversion itself.

In some embodiments, the vehicle data 22 may be provided to the management engine 114 in packets, where each packet contains data for one “measurement” of the vehicle's operating condition, taken at a given time. Referring for a moment to FIG. 3A, an example listing of vehicle data 22 is shown, organized in JSON format. Each line of data 22a shown in the listing represents a packet. Each packet includes a timestamp field 322a, a name field 322b, and a value field 322c. A measurement may be an actual measure of some operating aspect of the vehicle, for example, the speed of the vehicle, the oil level, the engine temperature, the angle of the steering wheel, and so on. A measurement may occur when there is change of state of the vehicle, for example, the operating state of the headlights (ON or OFF), the working state of a lamp (e.g., right side backup light is detected as being broken), a seatbelt has been engaged or released, the transmission gear has changed from one gear to another, a door is open, and so on. The packet may include, in addition to the measured datum, a timestamp (e.g., identifies year, month, date, time) for when the measurement was taken, an identifier of the measurement data, and an identifier of the vehicle.

In some embodiments, information about the driver may be provided to the platform 102 as a packet of vehicle data 22. For example, before a driver can operate the vehicle, the driver may have to log in to the on-board computer. The on-board computer may provide a vehicle identifier, a driver identifier, time of operation, and other driver-related data to the platform 102 as a packet of vehicle data 22. In some embodiments, the driver information may be collected in a transparent manner; e.g., each driver may have a key fob that is encoded with their information. The key fob may transfer that data to the on-board computer, which can then be communicated to the platform 102.

Returning to FIG. 3, at block 304, the management engine 114 stores the vehicle data 22 it receives from the vehicle connector modules 112 into the data storage system 14. In some embodiments, the platform 102 may receive vehicle data 22 from a vehicle in real time. In other words, the data that a vehicle 12 collects is sent to the platform 102 as soon as it is collected by the vehicle. Accordingly, in a scenario where there are many vehicles 12 in operation, each sending vehicle data 22 to the platform 102 in real time, there may be a need to buffer the received data. In some embodiments, therefore, the vehicle data 22 may be buffered by the vehicle connector module 112 that receives the data, or in other embodiments the data may be buffered by the management engine 114.

The management engine 114 may provide a mapping between the vehicle data 22 that is collected for a given vehicle 12 and the driver of that vehicle at the time the data was collected. For example, the management engine 114 may maintain a list of each driver who is currently operating a vehicle 12 and the vehicle's vehicle identifier. As vehicle data 22 is received, the management engine 114 may match the vehicle identifier contained in the vehicle data with the list of drivers and associate vehicle identifiers. The management engine 114 may store the vehicle data 22 in the data storage system along with the identifier of the driver; for example, by concatenating the driver identifier with the vehicle data.

At block 306, the analytics component 116 may perform various analytics on the stored data in response to requests made by a user (e.g., fleet manager). As explained above, the data analyses may be performed in real time on vehicle data 22 as the data is received by the platform.

At block 308, the management engine 114 may receive rules from a user and store them in the rules data store 120. In some embodiments, a rule may be expressed as predicates and conditions on the vehicle data 22. The rule may further express one or more actions that are triggered when the rule evaluates to TRUE. In some embodiments, the user may import rules into the platform 102. In other embodiments, the platform 102 may allow the user to define the rules on the platform using a suitable user interface provided by the platform.

At block 310, the management engine 114 may process the rules that are stored in the rules data store 120. A rule may trigger one or more actions. For example, one kind of action is the issuance of alerts (block 312); another kind of action is the triggering of activity in the backend systems 16 (block 314). Some rules may be simple; e.g., a rule may trigger an alert when the vehicle's speed exceeds a predetermined limit, when a flat tire has occurred, or the vehicle ran out of gas, and so on. The following rule, for example, will issue an alert when vehicle speed exceeds a predetermined value:

<Rule id=“001” name=“SpeedingViolationCheck” type=“SimpleData”>

<Condition>data.vehicle_speed > 90</Condition>
<Result type=“AlertMessage”>Driver @data.driver_name is
speeding!</Result>

</Rule>

The alert message “Driver John Smith is speeding!” may issue, where the variable @data.driver_name is replaced by the driver of the vehicle, for example, John Smith.

Other more complex rules may be based on several vehicle measurements; e.g., a rule to test for a dangerous driving patterns may involve analyzing steering wheel angle, vehicle speed, acceleration measurements, and so on. The following rule, for example, involves computing fuel efficiency for each driver by invoking a method identified by the tag AnalyticsQuery:

<Rule id=“002” name=“FuelEfficiencyCheck” type=“DataAnalytics”>

<AnalyticsQuery id=“calcFuelEfficiencyByDriver”/>
<Condition>calcFuelEfficiencyByDriver.value > 50</Condition>
<Result type=“AlertMessage”>Driver @{data.driver_name}fuel
efficiency is low.</Result>

</Rule>

In some embodiments, alerts may manifest as messages sent to a user (e.g., fleet manager). For example, if the user is logged in on the platform 102 at a system console, the alert may appear as a pop up window with a suitable message. The message may be emailed, texted, or otherwise communicated to the user if they are not at a system console. Alerts may be sent to the driver. For example, the alert may be sent via a vehicle connector module 112 to the vehicle 12 and then presented to the driver; e.g., via an on-board computer or on a mobile device carried by the driver.

Another kind of action that a rule may trigger is activity in the backend systems 16 of the enterprise (block 314). Some rules, for example, may trigger a backend system to create a purchase order to order vehicle parts or to arrange for service calls. For example, a rule that monitors vehicles' oil levels may trigger a service order for an oil change when the oil level for a vehicle falls below a certain level. Other rules may trigger data updates in one or more of the backend systems 16. Still other rules may initiate a workflow in the backend systems 16, and so on. The following rule, for example, invokes a purchase request action called PurchaseRequest1:

<Rule id=“003” name=“BrakesTearCheck” type=“DataAnalytics”>

<AnalyticsQuery id=“calcBrakeWearTearByVehicle”/>
<Condition>calcBrakeWearTearByVehicle.value > 95%</Condition>
<Result type=“BEAction”>

<Action id=“PurchaseRequest1” systemid=“G3T”>

<Parameter name=“itemid” value=“brake disk #22334”/>
<Parameter name=“amount” value=“4”/>
<Parameter name=“vehicle”
value=“@{data.vehicle_id}”/>

</Action>

</Result>

</Rule>

FIG. 4 shows an illustrative process flow for processing rules in accordance with some embodiments of the disclosure. The flow is a very high level description of how rules are processed. The specific processing details will depend on the specifics of the rules.

At block 402, a rule is obtained from the rules data store 120. In accordance with the present disclosure, rules may be expressed as predicates and conditions on vehicle data 22. If the rule specifies previously collected vehicle data 22, then at block 404 the management engine 114 may access the data storage system 14 to access stored vehicle data. If the rule uses computed vehicle data 22, then the management engine 114 may access the data storage system 14 to access stored computed vehicle data. In other embodiments, the analytics component 116 may be invoked to perform the computations. If the rule specifies real time vehicle data 22, then at block 406 the management engine 114 may access use the vehicle data that it is receiving from the vehicle connector modules 112 and apply it to the rule.

At block 408, the rule is evaluated, and at block 410, if the rule evaluates to TRUE, the processing proceeds to block 412; otherwise processing returns to block 402 to process the next rule in the rules data store 120. At block 412, if the action or actions that are associated with the evaluated rule include issuing an alert, then at block 422 the alert is sent to a recipient. Depending on the nature of the alert, the rule may specify additional data to be provided with the alert. For example, if the alert is a flat tire situation, the additional information may include providing location information (e.g., from GPS data) of the vehicle. If the alert is a speeding vehicle situation, the additional information may be to include a history of the driver of the vehicle, and so on.

In some embodiments, the alert may the type of recipient of the alert; e.g., whether the recipient is a user (other than the driver of the vehicle), the driver of the vehicle, or both. If the recipient is the user, then the alert may be presented as a pop-up message on the user's display terminal. If the recipient is the driver, then the management engine 114 may correlate the vehicle data 22 that was used to evaluate the rule with the driver who is associated with that data. The alert may then be communicated to the driver, for example, via a suitable vehicle connector module 112.

At block 424, the alert may be stored in one or more of the enterprise backend systems 16. For example, alerts relating to a driver's behavior (speeding, reckless, etc.) may be stored with the driver's employee record (e.g., in the HR backend system 16) for subsequent evaluation purposes. Alerts relating to vehicle status may be stored to provide a history of problems with the vehicle, and so on. Processing may then proceed to block 414 to test for other kinds of actions.

At block 414, if the action(s) that are associated with the evaluated rule include initiating backend activity, then at block 432, the backend connector 118 may communicate with one or more of the enterprise's backend systems 16 to initiate a suitable business action. For example, if the evaluated rule relates to engine wear and tear, the backend activity may be to order parts for the vehicle. As another example, the backend activity may be to schedule an appointment with a service provide for maintenance service. The backend activity may include interacting with the user, for example, to set up a service appointment. In some embodiments, a rule may involve both an alert action and backend activity actions. For example, in the case of a flat tire, an alert may be issued to inform the user that one of their drivers has a flat tier, and the backend systems 16 may be invoked to place a service call to send out a repair truck.

Processing may proceed to block 418 where additional kinds of actions may be tested for and acted upon. After all actions have been acted upon, processing may return to block 402 to process the next rule in the rules data store 120.

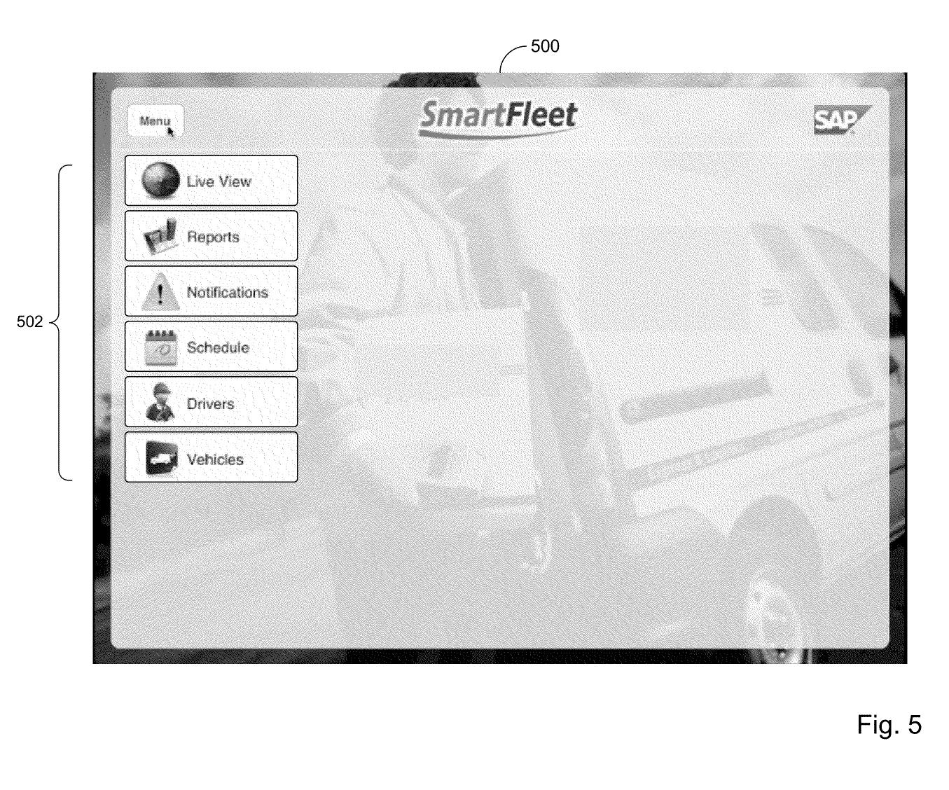

FIGS. 5-10A are screenshots of a graphical user interface (GUI) to illustrate various aspects of the platform 102 in accordance with the present disclosure. FIG. 5 shows an example of a startup screen 500, where the GUI presents several buttons 502 for accessing the various functionality of the platform 102. In some embodiments, the GUI may be displayed on the display unit of a desktop or laptop computer. The user may interact with the GUI using typical input devices such as a mouse and keyboard. In other embodiments, the GUI may be displayed on a mobile computing device such as a mobile phone or computing tablet. The GUI may be displayed on a touchscreen device and the user may interact with the GUI my making gestures on the touchscreen device such as taps, swipes, using a pen-type device, and so on.

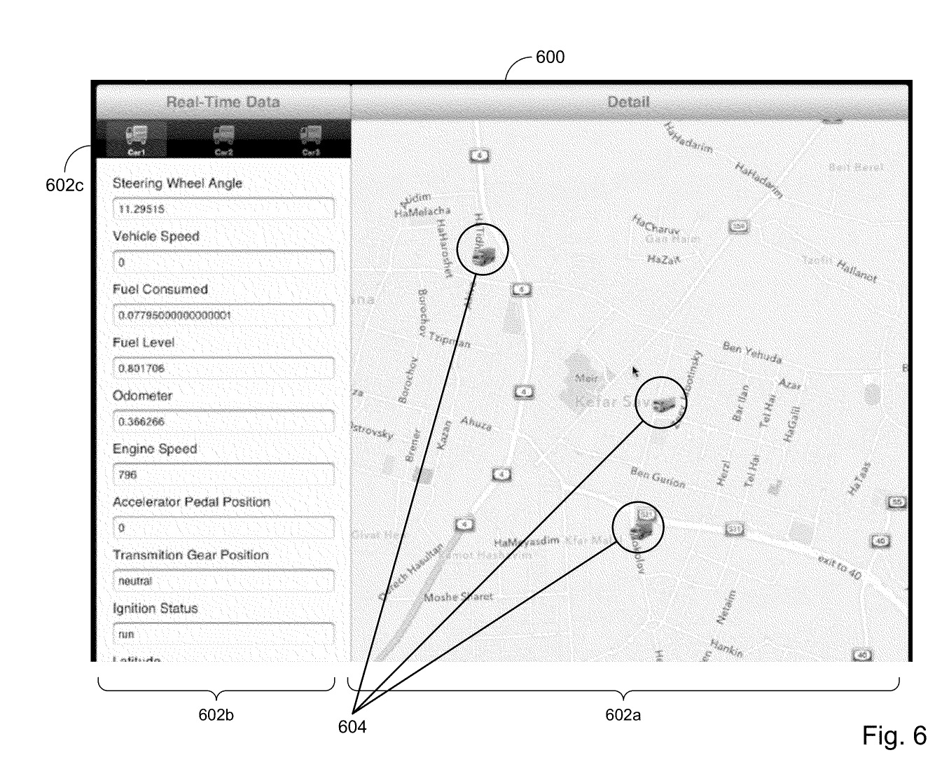

One of the buttons on the startup screen 500 is Live View, which allows a user to view vehicle data 22 (FIG. 1) in real time as the platform 102 is receiving the data. FIG. 6, for example, illustrates a Live View screen 600 that displays in real time vehicle data 22 from vehicles in operation. The Live View screen 600 may include a Detail area 602a that displays the current positions of some of the fleet's vehicles 604 on a map. The user may make a “drag” gesture in the Detail area 602a to reposition the map and reveal other vehicles in the fleet. The vehicles 604 in the Detail area 602a will be animated due to their changing positions in the Detail area as the platform 102 receives vehicle data 22 with new position information (e.g., GPS position information) for those vehicles.

The Live View screen 600 may include a Real-Time Data area 602b that displays the vehicle data 22 for a selected vehicle, in real time as the platform 102 receives vehicle data for the selected vehicle. The Real-Time Data area 602b may include a vehicle selection area 602c that allows the user to scroll through a list of vehicles in operation and select a vehicle of interest. As the platform 102 receives the vehicle data 22, each data fields comprising the Real-Time Data area 602b are updated with the values from the received data. The data fields comprising the Real-Time Data area 602b will therefore continue to change and update with new information.

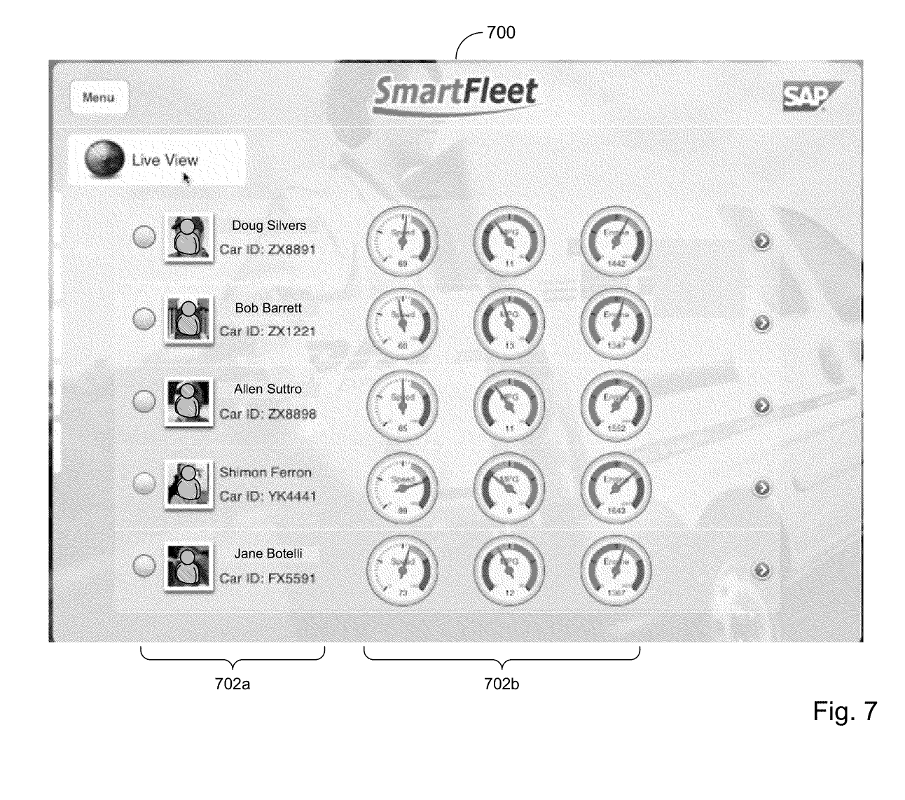

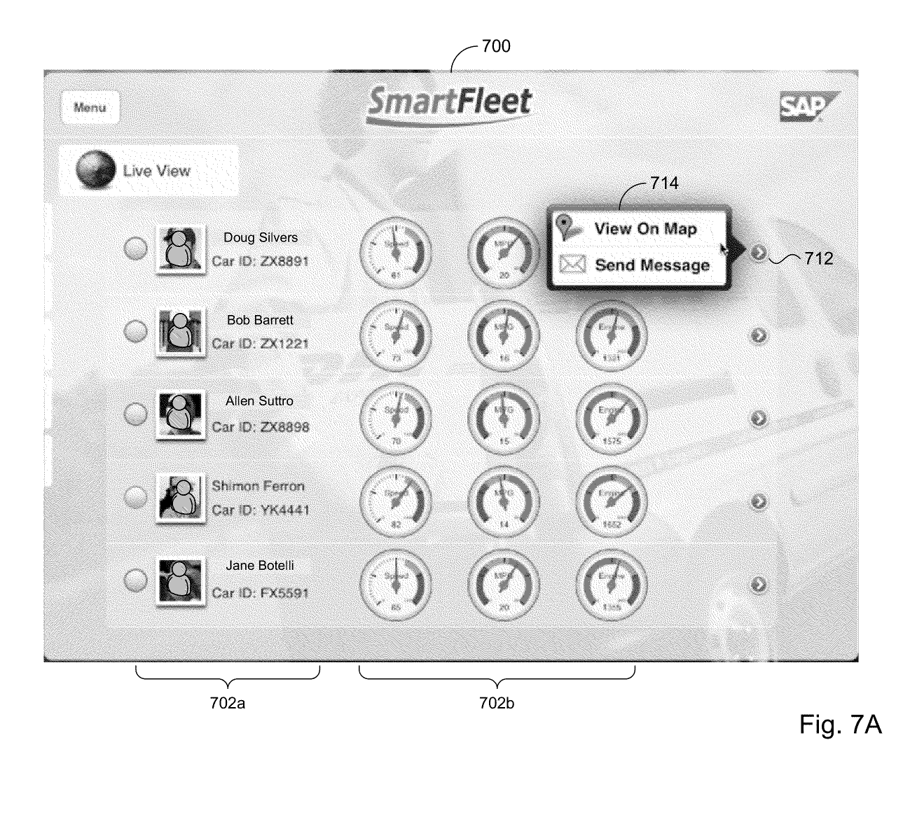

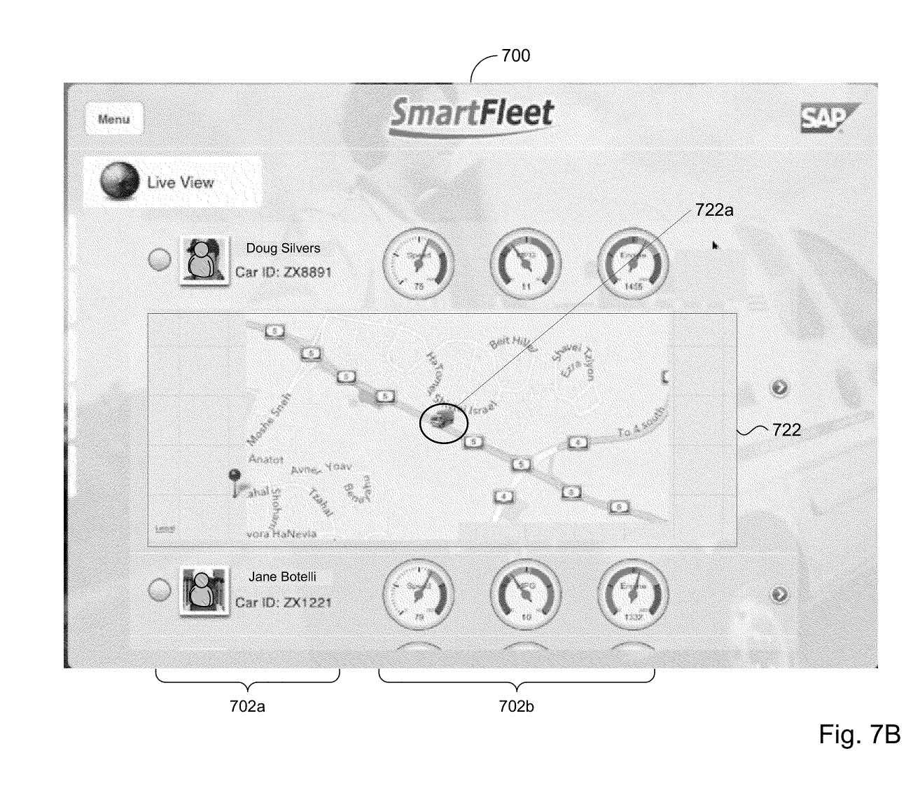

Another example of a Live View screen is illustrated by the Live View screen (dashboard) 700 shown in FIG. 7. Here, the dashboard 700 shows real time data on a driver by driver basis. A driver area 702a in the dashboard 700 identifies each driver, showing for example a picture of the driver, their name, and the vehicle they are driving. A vehicle data area 702b provides some of the vehicle data 22 for the vehicle being driven. In some embodiments, the data in the vehicle data area 702b may be graphically presented. For example, a speedometer image may be used to represent the vehicle's speed, a temperature gauge image may be used to represent the vehicle engine's temperature, and so on. The data vis-à-vis the images displayed in the vehicle data area 702b may be updated in real time as the platform 102 receives the vehicle data 22. Accordingly, the images displayed in area 702b will be animated (e.g., the needles in the gauges move) as the images are updated with newly received vehicle data 22.

Referring to FIG. 7A, a driver's progress on the road may be displayed by clicking on a button 712 to bring up a selection menu 714 and selecting an action to view a map. The display may be updated as illustrated in FIG. 7B to display a map 722 showing the location 722a of the selected driver. In some embodiments, the map 722 is displayed in real time, so that the driver's location 722a in the map is animated to represent the driver's changes in location as vehicle data 22 from the driver's vehicle is sent to the platform 102.

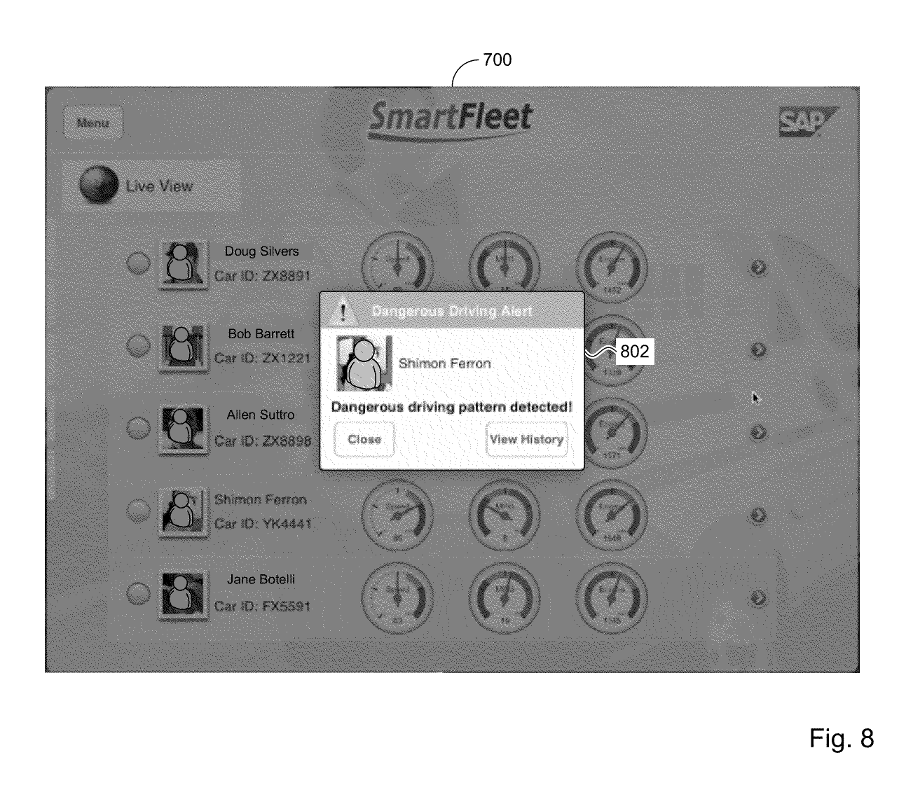

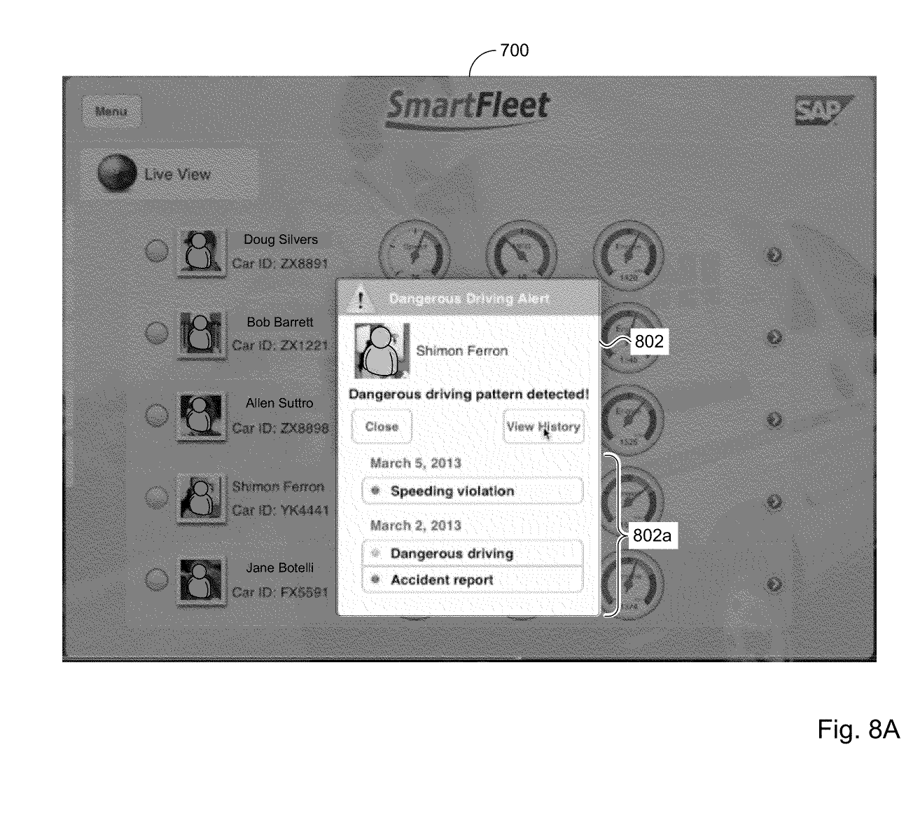

Referring to FIG. 8, the figure illustrates an alert may be presented to the user in accordance with the present disclosure. Suppose a driver Shimon Ferron has been identified as exhibiting a dangerous driving pattern; for example, a rule that defines a pattern of vehicle data deemed to represent dangerous driving evaluates to TRUE. The management engine 114 may display a pop-up alert message 802 on the display. In some embodiments, the alert message 802 may pop up on any screen that the user happens to be viewing; the alert message example shown in FIG. 8 happens to pop up on the Live View screen 700. The alert message 802 may include a “view history” button that the user may click on to obtain additional information about the driver. FIG. 8A illustrates an example showing the driver's driving history in a drop down portion 802a of the alert message 802. The additional information may be accessed from the enterprise's backend systems 16, for example, an HR database containing the driver's driving history.

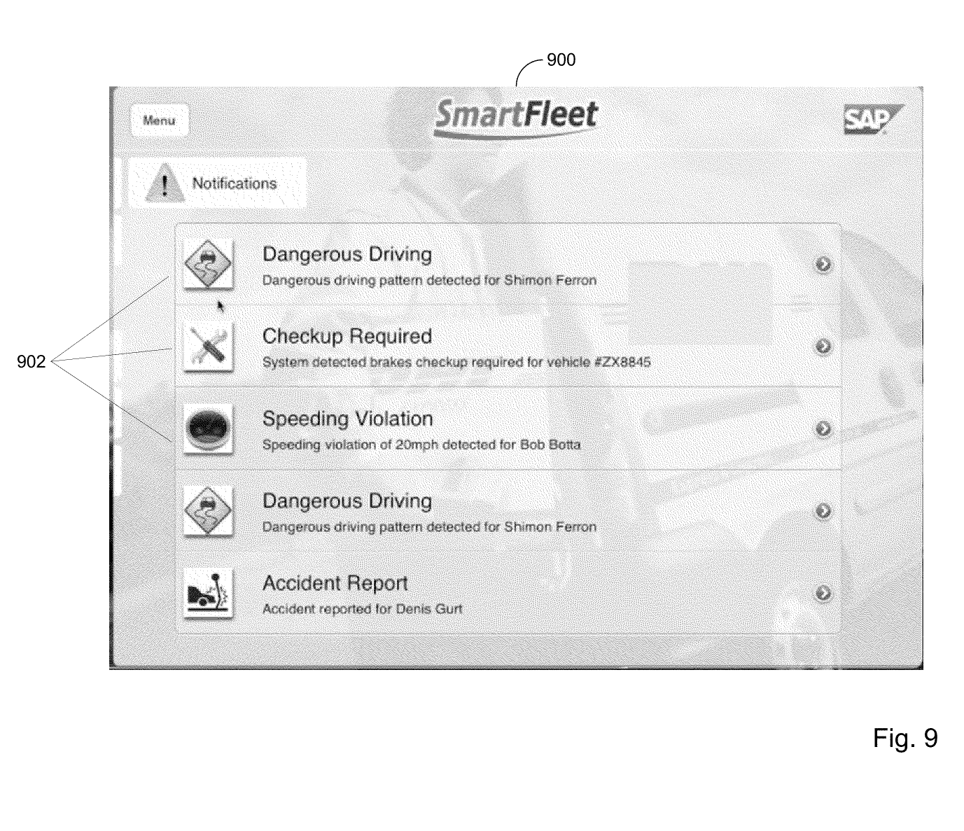

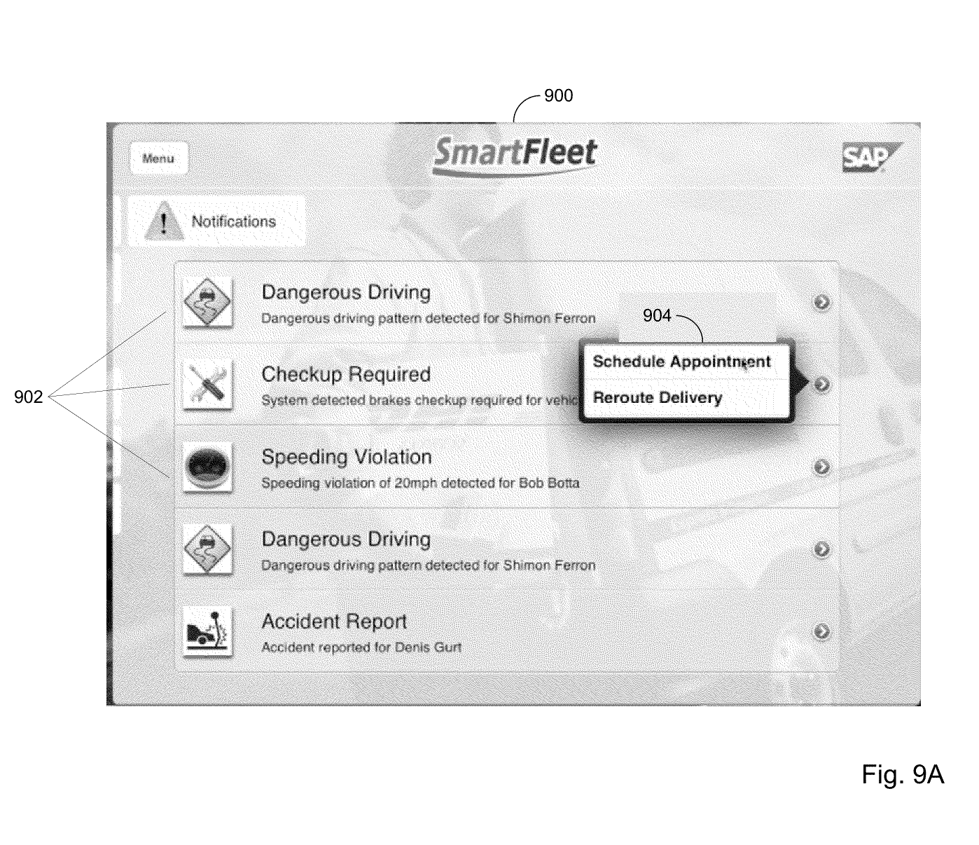

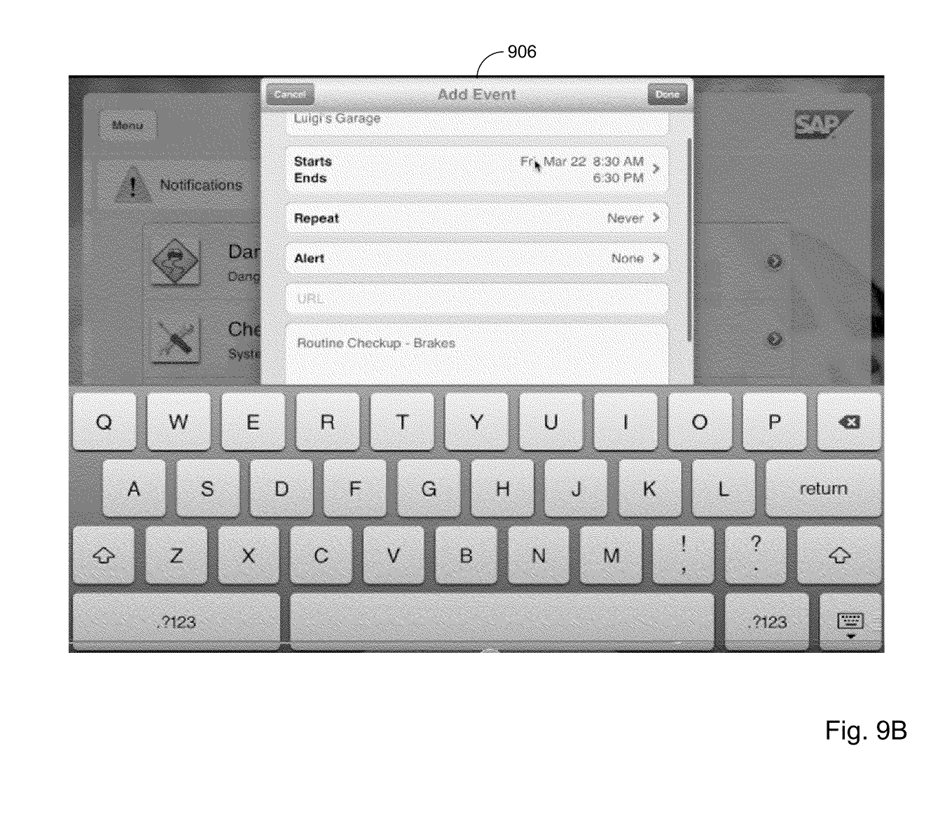

Returning to FIG. 5 for a moment, another button on the startup screen 500 is Notifications, which allows a user to view a listing of notifications that the platform 102 has issued. For example, as mentioned above in FIG. 3, alerts may be stored. The management engine 114 may access the stored alerts and present them in a notifications list. FIG. 9 illustrates a notifications display 900 in accordance with the present disclosure, listing different categories 902 of alerts. One of the alert categories is Checkup Required. Referring to FIG. 9A, if the user clicks on this category, a menu 904 may pop up to list the different actions that the user may take. If the user selects to schedule an appointment, the display may bring up a scheduling UI 906 as shown, for example, in FIG. 9B. When the user enters their data, the management engine 114 may communicate with the enterprise's backend systems 16 using the backend connector 118 to initiate a business process or workflow, for example, to coordinate with operations in the enterprise or outside suppliers to arrange for the scheduled service.

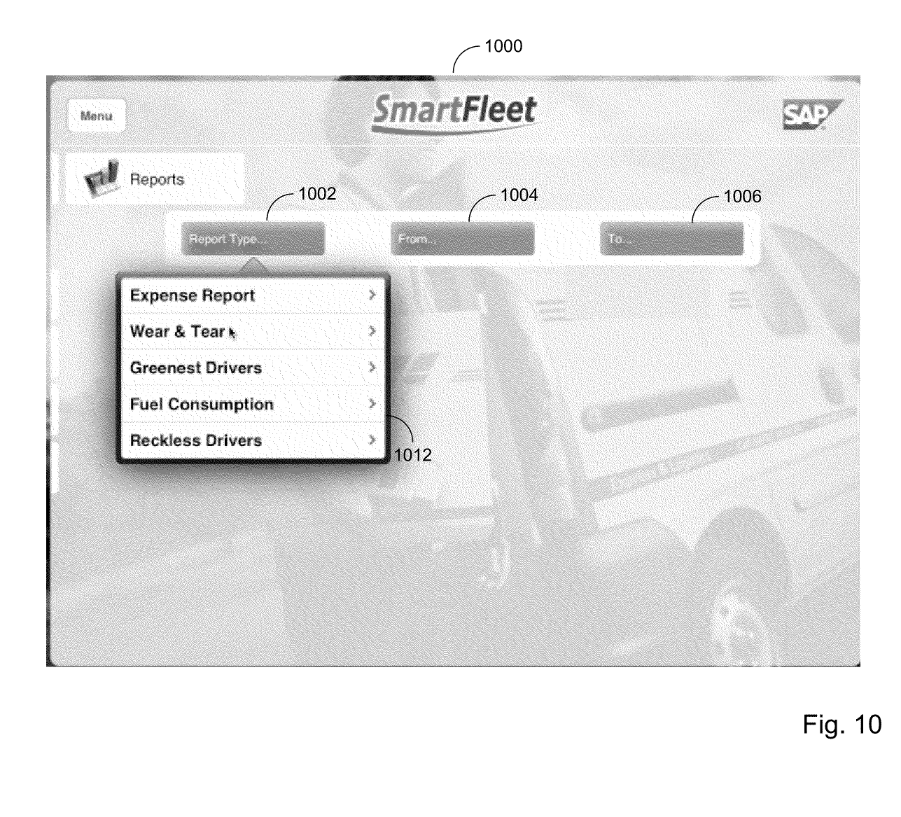

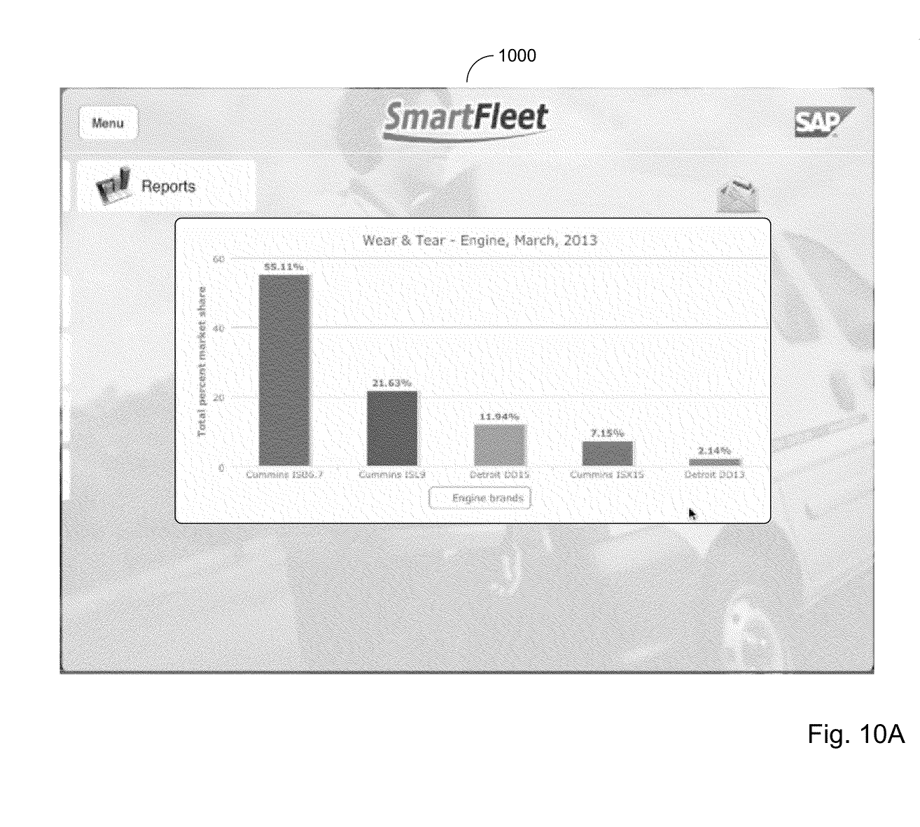

Returning again to FIG. 5 for a moment, another button on the startup screen 500 is Reports, for generating reports and other analytics from the vehicle data 22 stored in the data storage system 14; e.g., using the analytics component 116. FIG. 10 illustrates a reports display 1000, allowing a user to generate a report. The user may specify a report from a drop down menu 1012 accessed from a selection button 1002. The date range of the data to use in the report or analysis can be specified in the date fields 1004, 1006. In some embodiments, the date fields 1004, 1006 may display a calendar widget for selecting a date, or in other embodiments may be a fillable field. The user may specify to generate a report based on real time vehicle data 22 as the data is being received by the platform 102. After selecting a source of data, the user may then select from several report types, for example, bar charts, pie charts, graphs, and so on. FIG. 10A, for example, shows a bar chart for the selected report.

### Advantages and Technical Effect

A conventional vehicle management platform in an enterprise that maintains and manages a fleet of vehicles provides no integration with the large amounts of data collected on its vehicles and the enterprise's backend systems. The problem is two-fold: first, there is a vast amount of data that needs to be processed; and second there is the need to be able to take action based on vehicle data in a time1 fashion including calling to bear the resources afforded by the enterprise's backend systems.

A platform (e.g., platform 102) in accordance with the present disclosure advantageously integrates the collection and analysis of vehicle data with the enterprise's backend systems. The vehicle connector modules 112 are extendable to allow for communication with vehicles using current technology and future technology. The platform 102 enables aggregating large amounts of data using an in-memory database system (e.g., 14) and in an embodiment can provide for real time analytics using the SAP® HANA® database system.

The platform 102 provides access to the enterprise's backend systems 16, allowing various business processes and workflows to be initiated based on the vehicle data 22. In addition, alerts may be pushed to users of the platform 102 (e.g., managers) and to the drivers of the vehicles.

The above description illustrates various embodiments of the present disclosure along with examples of how aspects of the particular embodiments may be implemented. The above examples are presented to illustrate the flexibility and advantages of the particular embodiments as defined by the following claims. Other arrangements, embodiments, implementations and equivalents may be employed without departing from the scope of the present disclosure as defined by the claims.

We claim the following:

1. A computer-implemented method in an enterprise comprising:
receiving vehicle data from a plurality of vehicles that are being operated by drivers, wherein the vehicle data includes an indication of time, an identifier of a vehicle, an identification of a driver of the vehicle, current operating conditions of the vehicle, and current location information of the vehicle;
storing the vehicle data in a database;
evaluating first rules using the vehicle data and, based on outcomes of the evaluation, producing one or more alerts; and
evaluating second rules using the vehicle data and, based on outcomes of the evaluation, communicating with one or more backend systems of the enterprise to initiate one or more business activities in the one or more backend systems.

2. The method of claim 1 further comprising evaluating third rules using the vehicle data and, based on outcomes of the evaluation, producing one or more alerts and communicating with one or more backend systems of the enterprise to initiate one or more business activities in the one or more backend systems.

3. The method of claim 1 wherein evaluating the first rules and/or evaluating the second rules are performed using the vehicle data in real time, as the vehicle data is being received.

4. The method of claim 3 further comprising performing analytics on the vehicle data to generate computed vehicle data, wherein evaluating the first rules and/or evaluating the second rules include using the computed vehicle data.

5. The method of claim 3 further comprising correlating the computed vehicle data with one or more drivers of the vehicle for which the computed vehicle data was generated.

6. The method of claim 1 wherein the one or more business activities includes updating an employee database having stored therein employee data for the drivers of the vehicles.

7. The method of claim 1 wherein the one or more business activities includes communicating with one or more suppliers to obtain parts or service for one or more vehicles.

8. The method of claim 1 wherein some of the alerts are presented on a display device.

9. The method of claim 1 wherein some of the alerts are sent to one or more of the drivers.

10. A computer system in an enterprise comprising:
a vehicle communication module for wireless communication with a plurality of vehicles being operated by drivers, including receiving vehicle data from the plurality of vehicles;
a database system having stored therein the vehicle data received by the vehicle communication module;
a backend connector for communication with backend systems of the enterprise;
a computer processor; and
a memory having stored therein computer executable program code, which when executed by the computer processor, causes the computer processor to:
receive from the vehicle communication module vehicle data from a plurality of vehicles that are being operated by drivers, wherein the vehicle data includes an indication of time, an identifier of a vehicle, an identification of a driver of the vehicle, current operating conditions of the vehicle, and current location information of the vehicle;
store the vehicle data in the database system;
evaluate first rules using the vehicle data and, based on outcomes of the evaluation, producing one or more alerts; and
evaluate second rules using the vehicle data and, based on outcomes of the evaluation, communicating with one or more backend systems of the enterprise to initiate one or more business activities in the one or more backend systems.

11. The computer system of claim 10 wherein the computer executable program code, which when executed by the computer processor, further causes the computer processor to evaluate third rules using the vehicle data and, based on outcomes of the evaluation, producing one or more alerts and communicating with one or more backend systems of the enterprise to initiate one or more business activities in the one or more backend systems.

12. The computer system of claim 10 wherein evaluation of the first rules and/or evaluation of the second rules are performed using the vehicle data in real time, as the vehicle data is being received.

13. The computer system of claim 10 wherein the one or more business activities includes updating an employee database having stored therein employee data for the drivers of the vehicles.

14. The computer system of claim 10 wherein the one or more business activities includes communicating with one or more suppliers to obtain parts or service for one or more vehicles.

15. A non-transitory computer-readable storage medium having stored thereon computer executable program code, which when executed by a computer processor, causes the computer processor to:
receive vehicle data from a plurality of vehicles that are being operated by drivers, wherein the vehicle data includes an indication of time, an identifier of a vehicle, an identification of a driver of the vehicle, current operating conditions of the vehicle, and current location information of the vehicle;
store the vehicle data in a database;
evaluate first rules using the vehicle data and, based on outcomes of the evaluation, producing one or more alerts; and
evaluate second rules using the vehicle data and, based on outcomes of the evaluation, communicating with one or more backend systems of the enterprise to initiate one or more business activities in the one or more backend systems.

16. The-transitory computer-readable storage medium of claim 15 wherein the computer executable program code, which when executed by the computer processor, further causes the computer processor to evaluate third rules using the vehicle data and, based on outcomes of the evaluation, producing one or more alerts and communicating with one or more backend systems of the enterprise to initiate one or more business activities in the one or more backend systems.

17. The-transitory computer-readable storage medium of claim 15 wherein evaluation of the first rules and/or evaluation of the second rules are performed using the vehicle data in real time, as the vehicle data is being received.

18. The-transitory computer-readable storage medium of claim 15 wherein the one or more business activities includes updating an employee database having stored therein employee data for the drivers of the vehicles.

19. The-transitory computer-readable storage medium of claim 15 wherein the one or more business activities includes communicating with one or more suppliers to obtain parts or service for one or more vehicles.

20. The-transitory computer-readable storage medium of claim 15 wherein some of the alerts are presented on a display device and/or sent to one or more of the drivers.
